(19) United States
(12) Patent Application Publication
(10) Pub. No.: US 2025/0381490 A1
(43) Pub. Date: Dec. 18, 2025

(54) No-No Doll

(71) Applicant: Moniqua' Scott, Spring, TX (US)

(72) Inventor: Moniqua' Scott, Spring, TX (US)

(21) Appl. No.: 18/745,696

(22) Filed: Jun. 17, 2024

(51) Int. Cl. A63H 3/28; G06F 3/16

(52) U.S. Cl. CPC A63H 3/28; G06F 3/165

(57) ABSTRACT

(a) A fully clothed girl or boy doll containing sound buttons on the inside of the doll. The sound buttons are located inside of the doll at the anatomical parts: bottom, breast, vagina, penis, and mouth. When pressed by a holder of the doll, the sound button will state “No-No this is my (body part)! You can't touch! I will tell mommy and daddy!” The doll serves as a tool in describing basic anatomy and informing holders of basic anatomy boundaries.

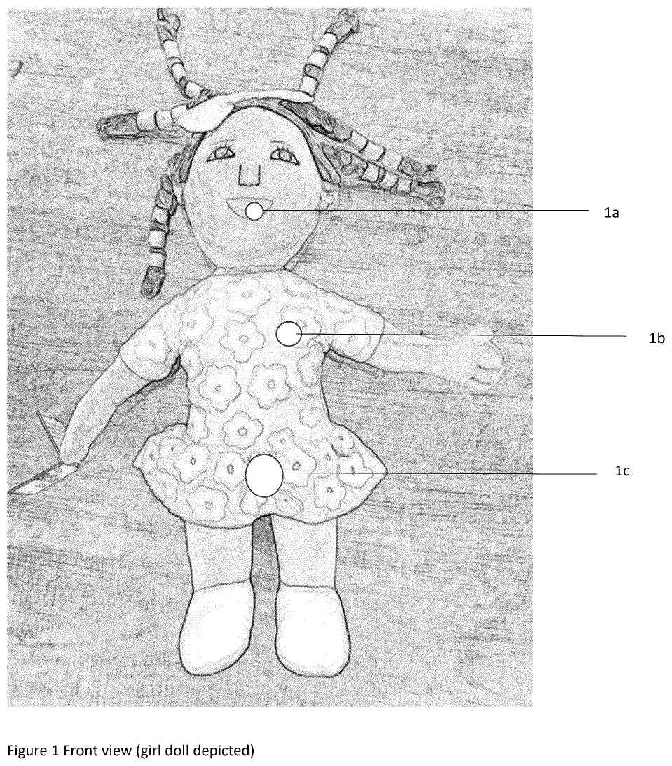

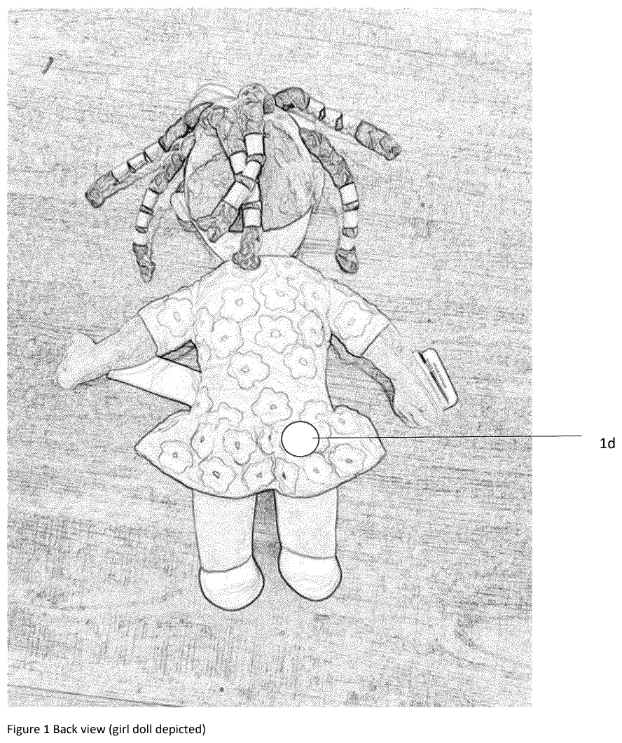

### ORIGIN OF THE INVENTION

This invention is inspired in part by familial experience and in part by profession and general awareness of the gross injustice to victims of child sexual abuse. This invention is born out of a desire to prevent child sexual abuse and to provide parents and those working with children a tool to break the ice on informing children of no-no zones.

### OBJECT OF THE INVENTION

The object of this invention is to provide holders with an informative/talking toy item that is usable to describe private areas of the body and offer a scripted response in relation to those areas.

### FIELD OF THE INVENTION

This invention relates to a child's play item describing the physical anatomy.

### BRIEF DESCRIPTION OF DRAWINGS

There are 2 drawings for reference of the girl make of the toy. The 2 drawings depict the front view and back view of the doll, respectively. (The boy doll is the generic appearance of a boy. The boy doll has a button which says penis instead of vagina. The boy doll does not contain the breast button).

### DETAILED DESCRIPTION

### Description of Figure

1a.—Voice button which when pressed says: “No-No” this is my mouth! You can't touch! I will tell mommy and daddy!”

1b.—Voice button which when pressed says: “No-No” this is my breast! You can't touch! I will tell mommy and daddy!”

1c.—Voice button which when pressed says: “No-No” this is my vagina! You can't touch! I will tell mommy and daddy!”

1d.—Voice button which when pressed says: “No-No” this is my bottom! You can't touch! I will tell mommy and daddy!”

1. A (boy or girl) doll describing the basic anatomy of the human body.
(a) By button activated voice recording: “bottom”, “breast”, “vagina”, “mouth” on the girl doll.
(b) By button activated voice recording: “bottom”, “penis”, “mouth” on the boy doll.

2. The sound recorder buttons within the (boy or girl) doll are placed in the respective anatomic parts within the doll and when pressed say the remarks listed below.
(a) “No-No” this is my bottom! You can't touch! I will tell mommy and daddy!
(b) “No-No” this is my breast! You can't touch! I will tell mommy and daddy!
(c) “No-No” this is my vagina! You can't touch! I will tell mommy and daddy!
(d) “No-No” this is my penis! You can't touch! I will tell mommy and daddy!
(e) “No-No” this is my mouth! You can't touch! I will tell mommy and daddy!

3. The (boy or girl) “No-No Doll” is fully clothed.

4. Whereby said doll described above will provide holders with a toy item which describes body parts and instructs on what to say in the event that the body part is touched.
